(19) United States
(12) Patent Application Publication
(10) Pub. No.: US 2023/0274644 A1
(43) Pub. Date: Aug. 31, 2023

(54) ACTION PLANNING DEVICE AND CONTROL ARITHMETIC DEVICE

(71) Applicant: Mitsubishi Electric Corporation, Tokyo (JP)

(72) Inventors: Shota KAMEOKA, Tokyo (JP); Rin ITO, Tokyo (JP); Hiroaki KITANO, Tokyo (JP)

(73) Assignee: Mitsubishi Electric Corporation, Tokyo (JP)

(21) Appl. No.: 18/016,455

(22) PCT Filed: Sep. 30, 2020
(86) PCT No.: PCT/JP2020/037138

§ 371 Date: Jan. 17, 2023

(51) Int. Cl. G08G 1/16

(52) U.S. Cl. CPC G08G 1/16

(57) ABSTRACT

An action planning device includes a plane-coordinate-system movement predictor that predicts the movement of an obstacle detected around the periphery of a moving object by an external sensor mounted on the moving object, in accordance with plane-coordinate-system obstacle information that expresses the obstacle in a plane coordinate system, and outputs a result of prediction as plane-coordinate-system obstacle movement information, a scene judgement part that judges the condition of the obstacle and outputs a situation in the moving object as scene information, and an action determination part that determines the action of the moving object in accordance with the scene information and outputs a result of determination as an action determination result. The control arithmetic device calculates a target value used to control the moving object, in accordance with the action determination result output from the action planning device.

### TECHNICAL FIELD

The present disclosure relates to an action planning device and a control arithmetic device in an autonomous driving system, the action planning device appropriately determining the action of a host vehicle, the control arithmetic device performing computation of a target value that is used to control the host vehicle on the basis of the determined action.

### BACKGROUND ART

In recent years, development is underway to achieve autonomous driving systems for causing automobiles to run autonomously. The autonomous driving systems need to appropriately determine the action of a host vehicle from the positions and speeds of obstacles around the periphery of the host vehicle, such as pedestrians, bicycles, and other vehicles. The action of the host vehicle as used herein refers to, for example, keeping the traffic lane, changing the traffic lane, or making a stop.

Patent Document 1 discloses a vehicle periphery information verification device and method for detecting obstacles around the periphery of a host vehicle, arranging the obstacles on a map, and determining the action of the host vehicle from the map. The vehicle periphery information verification device evaluates the reliability of the obstacle detection result by comparison between the positions of the obstacles and a travelable region and selects whether or not to apply the determined action on the basis of the evaluation result. This prevents erroneous determination of the action even if the accuracy of the obstacle detection is low.

Non-Patent Document 1 discloses a description of a high-precision map.

### PRIOR ART DOCUMENT

### Patent Document

Patent Document 1: WO2016/166790

### Non-Patent Document

Non-Patent Document 1: “Development of dynamic maps for automated driving”, System/Control/Information, Vol. 60, No. 11, pp. 463-468, 2016

### SUMMARY

### Problem to be Solved by the Invention

In order to determine the action of a host vehicle, it is necessary to judge the situation in the host vehicle on the basis of predictions about future movements of obstacles. A conventional vehicle periphery information verification device fails to refer to judging the situation in the host vehicle, and therefore it is difficult to appropriately determine the action of the host vehicle.

The present disclosure has been made in light of the problem described above, and it is an object of the present disclosure to provide an action planning device and a control arithmetic device that appropriately determines the action of a host vehicle in order to improve the accuracy of autonomous driving.

### Means to Solve the Problem

An action planning device according to the present disclosure includes a plane-coordinate-system movement predictor that predicts a movement of an obstacle in accordance with plane-coordinate-system obstacle information and outputs a result of prediction as plane-coordinate-system obstacle movement information, the obstacle being detected around a periphery of a vehicle by an external sensor mounted on the vehicle, the plane-coordinate system obstacle information expressing the obstacle in a plane coordinate system, a scene judgement part that judges a condition of the obstacle in accordance with the plane-coordinate-system obstacle movement information and outputs a situation in the vehicle as scene information, and an action determination part that determines an action of the vehicle in accordance with the scene information and outputs a result of determination as an action determination result.

A control arithmetic device according to the present disclosure computes a target value that is used to control a vehicle in accordance with an action determination result output from the action planning device described above.

### Effects of the Invention

According to the present disclosure, the action planning device and the control arithmetic device judge the situation in the vehicle from predictions about the movements of obstacles. Therefore, it is possible to appropriately determine the action of the host vehicle and to improve the accuracy of autonomous driving.

### BRIEF DESCRIPTION OF DRAWINGS

FIG. 1 is a diagram showing one example of a configuration of a vehicle equipped with an action planning device and a control arithmetic device according to Embodiments 1 to 4.

FIG. 2 is a diagram showing one example of the action planning device and the control arithmetic device according to Embodiment 1.

FIG. 3 is a schematic diagram showing one example of a scene in a plane coordinate system according to Embodiment 1.

FIG. 4 is a schematic diagram showing one example of a finite-state machine in an action determination part according to Embodiments 1 to 4.

FIG. 5 is a schematic diagram showing one example of a target track received from an operation planning part according to Embodiments 1 to 4.

FIG. 6 is a block diagram showing one example of the action planning device and the control arithmetic device according to Embodiment 2.

FIG. 7 is a schematic diagram showing one example of a vehicle in the plane coordinate system and in a path coordinate system according to Embodiments 2 to 4.

FIG. 8 is a schematic diagram showing one example of the positional relationship between a vehicle and an obstacle when they are running around a curve according to Embodiments 2 to 4.

FIG. 9 is a schematic diagram showing one example of the positional relationship between a vehicle and road information when the vehicle is running around a curve according to Embodiments 2 to 4.

FIG. 10 is a schematic diagram showing one example of a scene in the path coordinate system according to Embodiments 2 to 4.

FIG. 11 is a block diagram showing one example of the action planning device and the control arithmetic device according to Embodiment 3.

FIG. 12 is a schematic diagram showing one example of the positional relationship between a vehicle and an obstacle when they are running around an intersection according to Embodiments 3 and 4.

FIG. 13 is a schematic diagram showing one example of the positional relationship between a vehicle and an obstacle when they are running around a T junction according to Embodiments 3 and 4.

FIG. 14 is a block diagram showing one example of the action planning device and the control arithmetic device according to Embodiment 4.

### DESCRIPTION OF EMBODIMENTS

Hereinafter, action planning devices and control arithmetic devices according to embodiments of the present disclosure will be described with reference to the drawings. In the following description, a host vehicle is simply referred to as a “vehicle,” and physical objects around the periphery of the host vehicle, such as pedestrians, bicycles, and other vehicles, are collectively referred to as “obstacles.”

### Embodiment 1

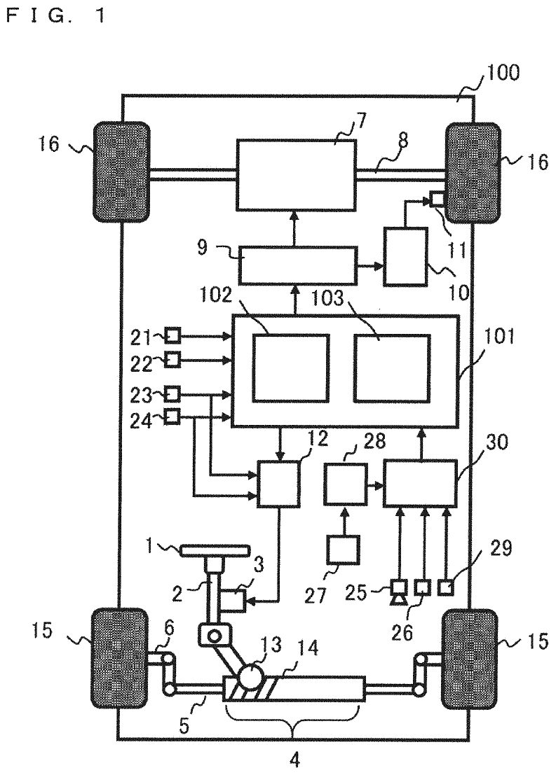

FIG. 1 is a diagram showing one example of a configuration of a vehicle 100 equipped with an action planning device 102 and a control arithmetic device 103 according to Embodiment 1. In FIG. 1, the action planning device 102 and the control arithmetic device 103 are collectively referred to as an autonomous driving system 101.

A steering wheel 1 provided for a driver (i.e., an operator) to operate the vehicle 100 is coupled to a steering shaft 2. The steering shaft 2 is connected to a pinion shaft 13 of a rack-and-pinion mechanism 4. The rack-and-pinion mechanism 4 includes a rack shaft 14 that is reciprocally movable in response to the rotation of the pinion shaft 13 and whose right and left ends are each connected to a front knuckle 6 via a tie rod 5. The front knuckles 6 rotatably support front wheels 15, which serves as steering wheels, and are also supported by a vehicle body frame so as to be steerable.

A torque produced as a result of the driver operating the steering wheel 1 rotates the steering shaft 2, and the rack-and-pinion mechanism 4 moves the rack shaft 14 in the right-left direction in accordance with the rotation of the steering shaft 2. The movement of the rack shaft 14 causes the front knuckles 6 to turn about a kingpin shaft, which is not shown, and thereby causes the front wheels 15 to steer in the right-left direction. Thus, the driver is able to change the lateral shift of the vehicle 100 by operating the steering wheels 1 when moving the vehicle 100 forward and backward.

The vehicle 100 includes internal sensors 20 for adjusting the running state of the vehicle 100, such as a speed sensor 21, an inertial measurement unit (IMU) sensor 22 that measures the inertia of the vehicle, a steering angle sensor 23, and a steering torque sensor 24.

The speed sensor 21 is mounted on a wheel of the vehicle 100 and includes a pulse sensor that detects the rotational speed of the wheel. The speed sensor converts output of the pulse sensor into a vehicle speed value and outputs the vehicle speed value.

The IMU sensor 22 is provided on the roof of the vehicle 100 or in the interior of the vehicle 100 and detects acceleration and angular velocity of the vehicle 100 in a vehicle coordinate system. For example, the IMU sensor 22 may have a micro electric mechanical system (MEMS) or a fiber optic gyroscope incorporated therein. The vehicle coordinate system as used herein refers to a coordinate system that is fixed to the chassis or body of the vehicle 100. Ordinarily, the vehicle coordinate system has the centroid of the vehicle 100 as its origin and defines that a forward direction in the longitudinal direction of the vehicle 100 is the x axis, the left-hand direction of the vehicle 100 is the y axis, and the direction in which a right-hand screw advances is the z axis, the right-hand screw rotating in the y-axis direction using the x axis as the origin.

The steering angle sensor 23 is a sensor that measures the rotation angle of the steering shaft 2 and may be configured as, for example, a rotary encoder.

The steering torque sensor 24 is a sensor that measures the rotational torque of the steering shaft 2 and may be configured as, for example, a strain gage.

The vehicle 100 further includes external sensors for recognizing situations around the periphery of the vehicle 100, such as a camera 25, a radar 26, a global navigation satellite system (GNSS) sensor 27, and a light detection and ranging (LiDAR) 29.

The camera 25 is mounted in a position in which the camera is capable of capturing images of the front, side, and back of the vehicle 100, and acquires information indicating an environment in front of the vehicle 100 from the captured images, the information including information about traffic lanes, mark lines, and obstacles.

The radar 26 irradiates the front of the vehicle 100 with radar and detects reflected waves therefrom so as to measure the relative distances and speeds of obstacles in front of the vehicle 100 and output the result of measurement.

The GNSS sensor 27 is connected to a GNSS antenna, which is not shown. The GNSS sensor 27 receives a positioning signal from a positioning satellite that is orbiting on a satellite orbit by the GNSS antenna, analyzes the received positioning signal, and outputs information about the position of the phase center of the GNSS antenna (e.g., latitude, longitude, height, and orientation). Examples of the positioning satellite include the United States' Global Positioning System (GPS), the Russia's Global Navigation Satellite System (GLONASS), the European Galileo, the Japanese Quasi-Zenith Satellite System (QZSS), the Chinese Beidou, and the Indian Navigation Indian Constellation (NavIC). The GNSS sensor 27 may use any of these systems.

The LiDAR 29 is mounted on, for example, the roof of the vehicle 100. The LiDAR 29 irradiates the periphery of the vehicle 100 with laser and detects a time difference until the laser is reflected from peripheral physical objects, so as to detect the positions of the physical objects in a vehicle coordinate system. In recent years, wider range and higher precision object detection is also made possible by mounting the LiDAR 29 at the four corners of the vehicle 100.

A navigation device 28 retains map information S15 and has the function of computing a traveling route that is accessible to a destination on the basis of the map information S15, the positional information about the vehicle 100 acquired by the sensors such as the GNSS sensor 27, and destination information that is set by the driver, and then outputting navigation information. The navigation device 28 further has the function of recognizing the fact such as that the periphery of the vehicle 100 is an intersection area and outputting the result of recognition, and the function of computing an instruction to change the traffic lane or the timing thereof that are necessary for the vehicle to reach the destination, and outputting the result of computation.

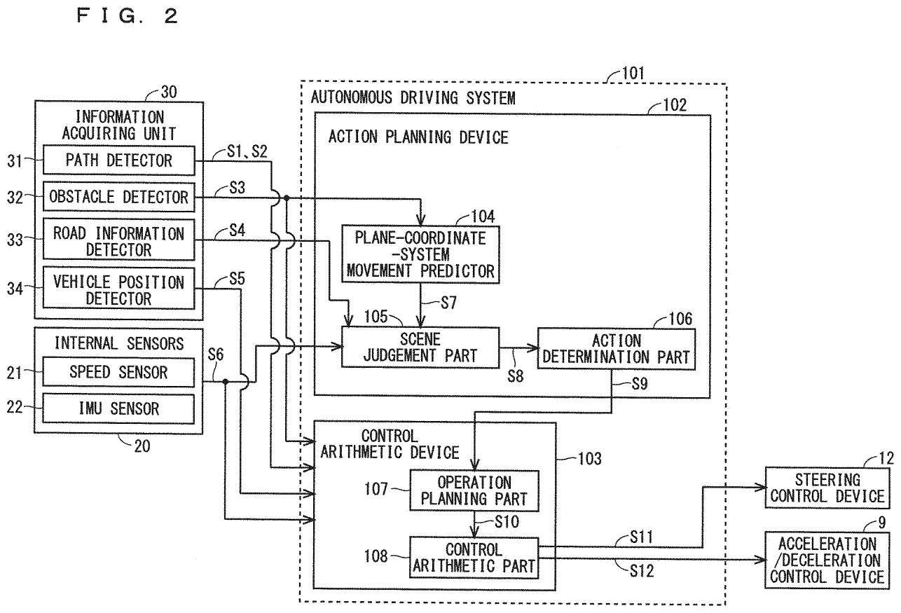

An information acquiring unit 30 is connected to the external sensors such as the camera 25, the radar 26, and the LiDAR 29 and performs processing for integrating the information acquired from the external sensors so as to detect information about the periphery of the vehicle 100, such as obstacle information, and outputs the detected information to the autonomous driving system 101. The information acquiring unit 30 is also connected to the navigation device 28 and detects the position of the vehicle 100 based on the GNSS sensor 27. The details of the information acquiring unit 30 will be described later with reference to FIG. 2.

The autonomous driving system 101 includes the action planning device 102 and the control arithmetic device 103. The action planning device 102 determines the action of the vehicle 100 on the basis of the information received from the information acquiring unit 30 and the information received from the internal sensors 20 and outputs an action determination result S9 to the control arithmetic device 103. The control arithmetic device 103 computes a target value that is used to control the vehicle 100 in accordance with the action determination result S9 received from the action planning device 102. The target value as used herein refers to, for example, a target steering amount S11 that collectively refers to a target steering angle and a target steering torque, and a target acceleration/deceleration amount S12.

The vehicle 100 further includes an electric motor 3 for achieving lateral motion of the vehicle 100, a vehicle driving device 7 for controlling longitudinal motion of the vehicle 100, and an actuator such as a brake 11.

The electric motor 3 is generally configured by a motor and a gear and freely rotates the steering shaft 2 by applying a torque to the steering shaft 2. That is, the electric motor is capable of causing the front wheels 15 to steer freely, independently of the driver's operation of the steering wheels 1.

The steering control device 12 computes a current value that is to be supplied to the electric motor 3 so as to cause the steering of the vehicle 100 to follow the target steering amount S11 on the basis of the outputs received from the steering angle sensor 23 and the steering torque sensor 24 and the target steering amount S11 received from the autonomous driving system 101, and outputs current corresponding to the calculated current value.

The vehicle driving device 7 is an actuator for driving the vehicle 100 in the back-and-forth direction. For example, the vehicle driving device 7 rotates the front wheels 15 and the rear wheels 16 by, for example, transmitting a driving force thereto via a transmission (not shown) and the shaft 8, the driving force being obtained from a driving source such as an engine or a motor. This allows the vehicle driving device 7 to freely control the driving force of the vehicle 100.

Meanwhile, a brake control device 10 is an actuator for braking the vehicle 100, and controls the amount of breaking of the brake 11 mounted on the front wheels 15 and the rear wheels 16 of vehicle 100. A common brake 11 produces a braking force by pressing a pad against a disk rotor under an oil pressure, the disk rotor rotating together with the front wheels 15 and the rear wheels 16.

An acceleration/deceleration control device 9 computes the driving force and braking force of the vehicle 100 that are necessary to cause the acceleration and deceleration of the vehicle 100 to follow the target acceleration/deceleration amount S12 received from the autonomous driving system 101, and outputs the result of computation to the vehicle driving device 7 and the brake control device 10.

The internal sensors 20, the external sensors, and a plurality of devices described above are assumed to configure a network using, for example, a controller area network (CAN) or a local area network (LAN) in the vehicle 100. These devices are capable of acquiring information via the network. The internal sensors 20 and the external sensors are also capable of mutual data transmission and reception via the network.

FIG. 2 is a block diagram showing one example of the action planning device 102 and the control arithmetic device 103 according to Embodiment 1. FIG. 2 is a block diagram configured by the information acquiring unit 30, the internal sensors 20, the action planning device 102, the control arithmetic device 103, the steering control device 12, and the acceleration/deceleration control device 9. The action planning device 102 determines the action of the vehicle 100 on the basis of the information received from the information acquiring unit 30 and the information received from the internal sensors 20 and outputs the determined action as the action determination result S9. The control arithmetic device 103 computes the target value that is used to control the vehicle 100 on the basis of the information received from the information acquiring unit 30, the information received from the internal sensors, and the action determination result S9 received from the action planning device 102. The target value as used herein refers to the target steering amount S11 and the target acceleration/deceleration amount S12.

The information acquiring unit 30 includes a path detector 31, an obstacle detector 32, a road information detector 33, and a vehicle position detector 34.

The path detector 31 outputs a reference path S1 serving as a standard of running of the vehicle 100, and a travelable region S2 in which the vehicle 100 is travelable. The reference path S1 is the center line of a lane that is recognized by detecting mark lines using information such as the image data obtained from the camera. The reference path S1 may be other than the center line of the lane and may, for example, be a path that is given from an external source. For example, in the case where a path for automated parking is given from an external source in a parking area, this path may be used as the reference path S1. The reference path S1 may be expressed as, for example, a polynomial or a spline curve.

The travelable region S2 is calculated by processing for integrating the information acquired from the sensors such as the camera 25, the radar 26, and the LiDAR 29. For example, in the case where there is no obstacles on a road with right- and left-side mark lines, the travelable region S2 may be output as a region of the road that is surrounded by the right- and left-side mark lines. In the case where there are obstacles on the road, the travelable region S2 is output as a region that excludes regions of the obstacles from the region surrounded by the right- and left-side mark lines.

The obstacle detector 32 outputs plane-coordinate-system obstacle information S3. The plane-coordinate-system obstacle information S3 is obtained by integrating the image data received from the camera 25 and the information received from the radar 26 and the LiDAR 29. The plane-coordinate-system obstacle information S3 includes the positions and speeds of obstacles and the types of obstacles. The types of obstacles are classified as, for example, vehicles, pedestrians, bicycles, and motorbikes. The positions and speeds of the obstacles included in the plane-coordinate-system obstacle information S3 are expressed in the plane coordinate system, which will be described later. The coordinate system is, however, not limited to the plane coordinate system.

The road information detector 33 outputs road information S4. The road information S4 indicates a traffic light C1 at an intersection or any other location and the lighting state of the traffic light, which are detected by integrating the image data received from the camera 25 and the information received from the radar 26 and the LiDAR 29. The road information S4 is, however, not limited thereto and may indicate, for example, a stop line C3 provided before the traffic light C1.

The vehicle position detector 34 detects the position of the vehicle 100 based on the GNSS sensor 27 and outputs the detected position as vehicle positional information S5. The position of the vehicle 100 received from the GNSS sensor 27 is generally expressed in a planetographic coordinate system. The planetographic coordinate system usually regards the Earth as an ellipsoid and is expressed by a combination of longitude and latitude, which represent the horizontal position on the surface of the ellipsoid, and height, which represents the vertical position. By using an arbitrary point as a reference point in the planetographic coordinate system, conversion into a North-East-Down (NED) coordinate system or conversion into a plane coordinate system by Gauss-Kruger projection is made possible. The NED coordinate system is a coordinate system that has, as the origin, an arbitrary point expressed in the planetographic coordinate system and that defines the north direction, the east direction, and the vertically upward direction. The plane coordinate system is an XY-coordinate system that has two axes orthogonal to each other from its origin. The plane coordinate system is used to express, for example, the mark lines for identifying the boundaries of the road, the vehicle 100, and the positions of the obstacles. For example, the plane coordinate system may have the centroid of the vehicle 100 as its origin and defines the longitudinal direction of the vehicle 100 as a first axis and the left-hand direction as a second axis. In this case, the plane coordinate system matches the vehicle coordinate system. As another example, the plane coordinate system may have an arbitrary point on a map as its origin and define the east direction as a first axis and the north direction as a second axis. The vehicle position detector 34 has the function of converting the position of the vehicle 100 expressed in the planetographic coordinate system into that in the plane coordinate system and outputting the result of conversion as the vehicle positional information S5.

The internal sensors 20 include the speed sensor 21 and the IMU sensor 22. The internal sensors are mounted on the vehicle 100, detect the state quantity of the vehicle 100 based on the speed sensor and the IMU sensor 22, and output the detected quantity as sensor information S6. The speed sensor 21 and the IMU sensor 22 have been described with reference to FIG. 1, and therefore a description thereof shall be omitted.

The action planning device 102 includes a plane-coordinate-system movement predictor 104, a scene judgement part 105, and an action determination part 106.

The plane-coordinate-system movement predictor 104 predicts the movements of obstacles on the basis of the plane-coordinate-system obstacle information S3 received from the obstacle detector 32 and outputs the result of prediction as plane-coordinate-system obstacle movement information S7. That is, the plane-coordinate-system movement predictor 104 predicts the movements of obstacles on the basis of the plane-coordinate-system obstacle information S3 that expresses obstacles around the periphery of the vehicle, which are detected by the external sensors mounted on the vehicle 100, in the plane coordinate system, and outputs the result as the plane-coordinate-system obstacle movement information S7. The plane-coordinate-system movement predictor 104 predicts the movements of obstacles, using the speeds of the obstacles received from the obstacle detector 32 and assuming that the obstacles make uniform linear motion in the direction of the velocity. Assuming the uniform linear motion simplifies computation for the prediction by the plane-coordinate-system movement predictor 104 and reduces computational complexity. Although the plane-coordinate-system movement predictor 104 predicts the movements of obstacles in the same cycle as the operating cycle of the action planning device 102, the movements may be predicted from only the positions of the obstacles in each cycle if this cycle is short enough. In this case, the plane-coordinate-system obstacle information S3 received from the obstacle detector 32 indicates the positions of the obstacles.

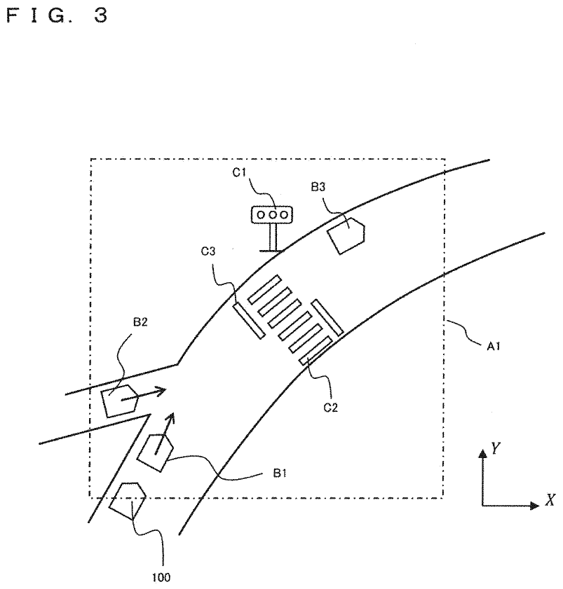

The scene judgement part 105 judges the conditions of obstacles, road circumstances, and the running progress of the vehicle 100, using the plane-coordinate-system obstacle movement information S7 received from the plane-coordinate-system movement predictor 104, the road information S4 received from the road information detector 33, and the sensor information S6 received from the internal sensors 20, and outputs the situation in the vehicle 100 as scene information S8. The details of the scene judgement part 105 will be described later with reference to FIG. 3 and Table 1. Alternatively, the scene judgement part 105 may use the plane-coordinate-system obstacle movement information S7 to judge the conditions of obstacles and output the situation in the vehicle 100 as the scene information S8. As another alternative, the scene judgement part 105 may use the plane-coordinate-system obstacle movement information S7 and the road information S4 to judge the conditions of obstacles and road circumstances and output the situation in the vehicle 100 as the scene information S8. It is, however, noted that the additional use of the road information S4 and the sensor information S6 enables judging a wider range of circumstances.

In order to judge the running progress of the vehicle 100, the scene judgement part 105 needs to detect the position of the vehicle 100 and is capable of detecting the position of the vehicle 100 via the internal sensor 20, but may also be capable of detection via the GNSS sensor 27. In this case, the position of the vehicle 100 is output as the vehicle positional information S5 from the vehicle position detector 34. Note that the GNSS sensor 27 is one of the external sensors. The external sensors are also capable of detecting road circumstances. Accordingly, the conditions of obstacles, road circumstances, and the running progress of the vehicle 100 are all detected by the external sensors.

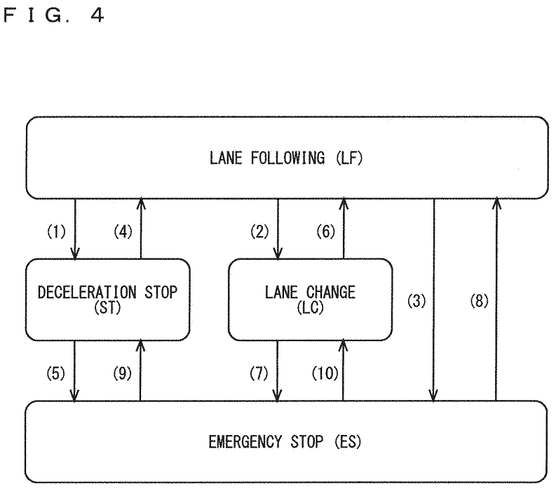

The action determination part 106 determines the action of the vehicle 100 on the basis of the scene information S8 received from the scene judgement part 105 and outputs the result of determination as the action determination result S9. The details of the action determination part 106 will be described later with reference to Tables 2 and 3 and FIG. 4.

The control arithmetic device 103 includes an operation planning part 107 and a control arithmetic part 108.

The operation planning part 107 generates and outputs a target vehicle speed and a target path along which the vehicle runs, using the action determination result S9 received from the action determination part 106, the reference path S1 and the travelable region S2 received from the path detector 31, the vehicle positional information S5 received from the vehicle position detector 34, and the sensor information S6 received from the internal sensor 20. Note that the target path and the target vehicle speed as used herein are collectively referred to as a “target track S10.”

The control arithmetic part 108 computes and outputs the target steering angle and the target acceleration/deceleration amount S12 so as to allow the vehicle 100 to follow the target track S10, using the target track S10 received from the operation planning part 107, the reference path S1 and the travelable region S2 received from the path detector 31, and the obstacle information received from the obstacle detector 32.

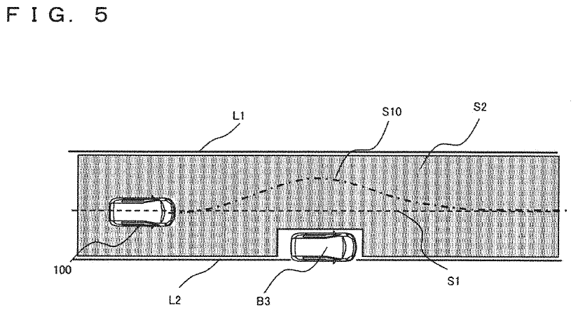

The control arithmetic device 103 does not necessarily have to include the operation planning part 107 if it does not generate the target track S10 and may compute the target steering amount S11 and the target acceleration/deceleration amount S12 directly from the action determination result S9 received from the action determination part 106. Alternatively, the control arithmetic device 103 may compute the target steering amount S11 and the target acceleration/deceleration amount S12 by model prediction control based on the action determination result S9 received from the action determination part 106, the reference path S1 and the travelable region S2 received from the path detector 31, and the obstacle information received from the obstacle detector 32. The details of the operations of the control arithmetic device 103 will be described later with reference to FIG. 5.

The steering control device 12 and the acceleration/deceleration control device 9 have been described with reference to FIG. 1, and therefore a description thereof shall be omitted.

Next, the scene judgement part 105 will be described with reference to FIG. 3 and Table 1. FIG. 3 is a schematic diagram showing one example of a scene in the plane coordinate system according to Embodiment 1. Table 1 is an explanatory diagram showing one example of the scene information S8 received from the scene judgement part 105 according to Embodiment 1. The scene information S8 may be expressed as variables that include numerical values, or may be expressed symbolically as, for example, a scene A and a scene B. The following description is given of a method in which the scene judgement part 105 expresses the scene information S8 as variables including numerical values.

TABLE 1

| Variable Name | Contents |
|---|---|
| tgtpos_inlane | 1: Stop line within judgement region |
| | 0: No stop lines |
| stoppos_reach | 1: Arrived at target stop position |
| | 0: Not arrived |
| obs_inlane | 1: Obstacle within judgement region |
| | 0: No obstacles |
| acrobs_inlane | 1: Crossing obstacle within judgement region |
| | 0: No crossing obstacles |
| oppobs_inlane | 1: Oncoming obstacle within judgement region |
| | 0: No oncoming obstacles |
| stopobs_inlane | 1: Stationary obstacle within judgement region |
| | 0: No stationary obstacles |
| fwdobs_inlane | 1: Preceding obstacle within judgement region |
| | 0: No preceding obstacles |
| stopobs_avd | 1: Unavoidable stationary obstacle within judgement |
| | region |
| | 0: Avoidable |
| obs_insurr | 1: Obstacles within region around vehicle |
| | 0: No obstacles |
| du_lc | 1: In the course of changing path |
| | 0: Path change completed |
| req_lc | 1: Path change instruction received from navigation |
| | device |
| | 0: No instructions |
| sig_state | 0: Traffic light is green |
| | 1: Traffic light is yellow |
| | 2: Traffic light is red |

As illustrated in FIG. 3, it is assumed that a preceding obstacle B1 (preceding vehicle), a crossing obstacle B2 (crossing vehicle), a stationary obstacle B3 (stationary vehicle), a traffic light C1, a pedestrian crossing C2, and a stop line C3 are present within a judgement region A1 around the periphery of the vehicle 100. The judgement region A1 as used herein refers to a range for which the scene judgement part 105 judges the conditions of obstacles, road circumstances, and the running progress of the vehicle 100. That is, the scene judgement part 105 judges such conditions and so on within the judgement region A1. The judgement region A1 is configured by a plurality of points (in the case of FIG. 3, points at the four corners of a rectangle) that are set in advance using information such as a map as a basis. In order to express the situation in the vehicle 100 numerically, the variables shown in Table 1 are prepared. For example, since the crossing obstacle B2 is present within the judgement region A1 in FIG. 3, the variable acrobs_inlane is 1. This can be judged on the basis of the plane-coordinate-system obstacle movement information S7 as to whether the direction of the velocity vector of the obstacle relative to the vehicle 100 is the direction of approaching the vehicle 100. Also, which color is indicated by the traffic light C1 can be judged by processing the road information S4, i.e., the image acquired by the camera 25. Although the scene judgement part 105 judges the conditions of obstacles, road circumstances, and the running progress of the vehicle 100 within the judgement region A1, the targets to be judged are not limited thereto, and the scene judgement part 105 may determine the conditions of obstacles that are currently outside the judgement region A1 but that are predicted to enter the judgement region A1 in the near future. The items used to judge the conditions and so on are not limited to the items shown in Table 1.

Next, the action determination part 106 will be described with reference to Tables 2 and 3 and FIG. 4. Table 2 is an explanatory diagram showing one example of the action determination result S9 received from the action determination part 106 according to Embodiment 1. FIG. 4 is a schematic diagram showing one example of a finite-state machine (hereinafter, referred to as the “FSM”) in the action determination part 106 according to Embodiment 1. Table 3 is an explanatory diagram showing one example of mode transition occurring in the action determination part 106 according to Embodiment 1.

TABLE 2
Items

Effectiveness
Target Action
Target Path Number
Reference Path Information
Upper Limit Speed
Lower Limit Speed
Target Stop Position
Target Stop Distance

TABLE 3

| | Transition | | | | |
|---|---|---|---|---|---|
| Current | Destination | Transition | Transition | | Representative |
| Mode | Mode | Number | Conditions | Transition Equation | Output |
| LF | ST | (1) | Stop line within | tgtpos_inline==1 | Set target stop |
| | | | judgement region; | &&sig_state==2 | position before |
| | | | traffic light is red | | stop line and |
| | | | | | compute and |
| | | | | | output target stop |
| | | | | | distance |
| | | | Crossing obstacle | acrobs_inlane==1 | Set target stop |
| | | | within judgement | | position before |
| | | | region | | crossing obstacle |
| | | | | | and compute and |
| | | | | | output target stop |
| | | | | | distance |
| | | | Oncoming | oppobs_inlane==1 | Set target stop |
| | | | obstacle within | | position before |
| | | | judgement region | | oncoming |
| | | | | | obstacle and |
| | | | | | compute and |
| | | | | | output target stop |
| | | | | | distance |
| | LC | (2) | Path change | req_lc==1 | Set target path |
| | | | instruction | | number to |
| | | | received from | | adjacent lane and |
| | | | navigation device | | output |
| | | | Unavoidable | stopobs_avd==1 | Set target path to |
| | | | stationary obstacle | | adjacent lane and |
| | | | within judgement | | output |
| | | | region | | |
| | ES | (3) | Obstacle within | obs_insurr==1 | Set upper limit |
| | | | region around | | speed to 0 and |
| | | | vehicle | | stop on the spot |
| ST | LF | (4) | Arrived at target | stoppos_reach==1 | |
| | | | stop position | | |
| | ES | (5) | Same as (3) | | |
| LC | LF | (6) | Path change | du_lc==0 | |
| | | | completed | | |
| | ES | (7) | Same as (3) | | |
| ES | LF | (8) | No obstacles | obs_insurr==0 | Output action |
| | | | within region | | determination |
| | | | around vehicle | | result before ES |

| | | |
|---|---|---|
| LC | (9) | Same as (8) |
| ST | (10) | Same as (8) |

Table 2 shows specific contents of the action determination result S9 output from the action determination part 106. Effectiveness indicates whether the result determined by the action determination part 106 is valid. This is the determination made by an autonomous driving device (not shown) as to whether the vehicle 100 is to be controlled by the action planning device 102 in a scene that cannot be handled by the action determination part 106 (e.g., a scene that is out of the specifications of autonomous driving such as an accident scene that cannot be expected, or a scene that lowers the accuracy or reliability of detection by the information acquiring unit 30). If Effectiveness is valid, the vehicle 10 is controlled using the action planning device 102. If Effectiveness is invalid, this means that the scene information S8 received from the scene judgement part 105 is not appropriate, and therefore processing such as stopping autonomous driving is performed. Target Action refers to the action to be executed by the vehicle 100 at the present moment or in the near future. Target Action may, for example, be the action of keeping running on the currently running path or the action of changing the path. Target Path Number indicates the ID and the number allocated to a target road when a path change is necessary. The ID and the number are allocated in local mode, using a section where the vehicle 100 is running as a reference. Alternatively, the ID and the number may be automatically allocated from the map information S15. Reference Path Information is information about the reference path S1. Specifically, Reference Path Information may indicate coordinate values of a point group that is used to express the reference path S1, or parameters of a polynomial or a spline curve that is used to express the reference path S1. Upper Limit Speed is the speed based on the legal speed of vehicles. Lower Limit Speed is the speed that is at least necessary for the vehicle 100. Target Stop Position T is the position such as the stop line C3 at which the vehicle 100 is to be stopped. Target Stop Distance is the distance from the current position of the vehicle 100 to the target stop position T. These items shown in Table 2 may be expressed, for example, numerically. In this case, for example, the value “1” may be allocated when Effectiveness is valid, and the value “0” may be allocated when Effectiveness is invalid. The action determination part 106 outputs at least one of the items shown in FIG. 5 as the action determination result S9.

The control arithmetic device 103 determines the action of the vehicle 100, using the action determination result S9 received from the action determination part 106. For example, the action of the vehicle 100 shown in Table 2 is used to set constraints on the operation planning part 107. If path following is set as the action of the vehicle 100, the operation planning part 107 generates the target track S10 so as to maintain the running of the vehicle within the mark lines. If a path change is set as the target action, the vehicle needs to straddle a mark line, and accordingly the operation planning part 107 excludes this mark line from the constraints and generates the target track S10 by expanding the travelable region S2 up to a path to which the vehicle's path is to be changed.

The action determination result S9 received from the action determination part 106 is not limited to that shown in Table 2. It is desirable that the items of the action determination result S9 are set in accordance with the control arithmetic device 103. For example, if the control arithmetic device 103 requires the upper- or lower-limit acceleration and the steering angle, these may also be included in the items of the action determination result S9. The items of the action determination result S9 may further include information about the function of the control arithmetic device 103, such as a lane keeping system (LKS) function of performing control to keep the lane, an adaptive cruise control (ACC) function of appropriately controlling the space of the vehicle from the preceding vehicle and the speed of the vehicle relative to the speed of the preceding vehicle, or a traffic jam assist (TJA) function of following the preceding vehicle.

FIG. 4 and Table 3 are explanatory diagrams for describing a technique with which the action determination part 106 outputs the action determination result S9. Specifically, the action determination part 106 determines an action, using the FSM. The FSM first determines a finite number of modes and transition conditions for these modes. The modes and transition conditions for these modes are desirably designed based on scenes for autonomous driving, but here, the FSM illustrated in FIG. 4 is assumed to be used by way of example. Note that the FSM is not limited to the example illustrated in FIG. 4. As illustrated in FIG. 4, four modes including Path Following (hereinafter, referred to as “LF (Lane Following)”), Deceleration Stop (hereinafter, referred to as “ST (Stop)”), Path Change (hereinafter, referred to as “LC (Lane Change)”), and Urgency Stop (hereinafter, referred to as “ES (Emergency Stop)”) are set as the modes. LF is the mode of running on the same path. ST is the mode that is selected when the vehicle makes a stop, such as when the vehicle stops before the stop line C3 or the crossing obstacle B2. LC is the mode of changing the path to an adjacent path N. ES is the mode of making an urgency stop when obstacles are present around the periphery of the vehicle 100.

As shown in FIG. 4 and Table 3, the action determination part is designed to allow transition between modes through the use of the scene information S8 received from the scene judgement part 105. Current Mode in Table 3 represents the current mode of the vehicle 100, and LF is assumed to be the initial mode at, for example, the start of autonomous driving, i.e., the mode starts from LF. Transition Destination Mode represents the next mode that the vehicle transitions to on the basis of the current mode and the transition conditions. Transition Number indicates the transition from the current mode to the transition destination mode by number, and here, (1) to (10) are assigned as Transition Number. That is, (1) to (10) in Table 3 correspond respectively to (1) to (10) in FIG. 4. Transition Conditions represent conditions for each transition and correspond to Table 1. Transition Equation represents the transition conditions as conditional expressions. Like Transition Number (1), some transition numbers may include a plurality of transition equations. Representative Output represents the item that causes a change in the behavior of the vehicle 100 during transition, among the items shown in Table 2.

By way of example, Transition Number (1) will be described. A case is assumed in which, when the vehicle 100 runs on a path in the LF mode, the traffic light C1 and the stop line C3 are present before the vehicle, and the traffic light C1 indicates red. In this case, the scene judgement part 105 outputs, to the action determination part 106, information indicating that tgtpos_inlane=1 (the stop line C3 is present within the judgement region A1) and sig_state=2 (the traffic light C1 indicates red). The action determination part 106 determines that the transition equation “tgtpos_inlane==1 && sig_state==2” is satisfied, and executes the transition corresponding to Transition Number (1). That is, the action determination part 106 transitions the mode of the vehicle 100 from the current LF mode to the ST mode. At this time, the action determination part 106 sets the target stop position T before the stop line C3, computes the target stop distance, and outputs the result of computation as the action determination result S9. Upon receipt of the action determination result S9 output in this way, the operation planning part 107 in the control arithmetic device 103 generates the target track S10 for stopping the vehicle before the stop line C3. Then, the control arithmetic part 108 computes the target steering amount S11 and the target acceleration/deceleration amount S12 such that the vehicle 100 follows the target track S10. Accordingly, the vehicle 100 makes a stop.

Although only the description of Transition Number (1) has been given here, the transition destinations for the other transition numbers are also determined in the same manner and used to determine the action of the vehicle 100. Note that cases are conceivable in which a plurality of transition conditions shown in Table 3 are satisfied at the same time. As one example, a case is conceivable in which the current mode is LF and both acrobs_inlane=1 (the crossing obstacle B2 is present within the judgement region A1) and req_lc=1 (an instruction to change the path is received from the navigation device) are satisfied. In this case, two transition destination modes ST and LC are conceivable, and which of them is to be selected is unknown. Thus, in the case where there is a plurality of candidates for the transition destination mode, a predetermined order of priority is used as a reference to determine the transition destination mode. For example, in the case where the crossing obstacle B2 is present within the judgement region A1 or in the case where an oncoming obstacle B4 is present within the judgement region A1, a transition destination mode that prompts the vehicle 100 to stop is preferentially selected in order to avoid a collision of the vehicle 100 with the obstacle.

As described above, the action determination part 106 determines the action of the vehicle 100 in consideration of not only the obstacles around the periphery of the vehicle 100 but also the road information S4 such as the traffic light C1. This allows various circumstances around the periphery of the vehicle 100 to be taken into consideration in determining the action of the vehicle 100 and accordingly expands the range of application of autonomous driving. Although the method in which the action determination part 106 uses the FSM has been described thus far, the FSM is desirably designed based on conceivable scenes or specifications of autonomous driving. Accordingly, the present disclosure is not limited to the design of the FSM described with reference to Tables 2 and 3 and FIG. 4. Moreover, the method of determining the action of the vehicle 100 is not limited to the method of using the FSM. For example, various methods are usable, such as a method of using a state transition diagram, a method of training, for example, a neural network in advance and using the neural network, and a method of using an optimization technique. Although the case in which the scene judgement part 105 outputs numerical values has been described thus far, the FSM or the like may also be usable even in the case where the scene determiner 105 outputs a symbolic expression.

Next, the operations of the control arithmetic device 103 will be described with reference to FIG. 5. FIG. 5 is a schematic diagram showing one example of the target track S10 received from the operation planning part according to Embodiment 1. FIG. 5 is a specific explanatory diagram for describing the target track S10 output from the operation planning part 107 in order to avoid the stationary obstacle B3. The action determination part 106 is assumed to determine the action of avoiding the stationary obstacle B3 within the travelable region S2 surrounded by a left-side mark line L1 and a right-side mark line L2. On the basis of the action determination result S9 received from the action determination part 106, the operation planning part 107 predicts the movements of the vehicle 100 and the obstacles with higher accuracy, using a movement model of the vehicle 100. Then, the operation planning part 107 generates a safe avoidance path as the target track S10 within the travelable region S2 and outputs the target track S10 to the control arithmetic part 108. Although not illustrated in FIG. 5, in the case where the vehicle makes a stop due to the red traffic light C1, the operation planning part 107 generates the target track S10 that allows the vehicle to accurately stop at the target stop position T, which is one of the action determination result S9, and outputs the target track S10 to the control arithmetic part 108.

According to Embodiment 1 described above, the situation in the vehicle 100 is determined based on the obstacle movement information and the road information S4. Thus, it is possible to appropriately determine the action of the vehicle 100 in consideration of not only obstacles but also the road information S4 and thereby to improve the accuracy of autonomous driving.

### Embodiment 2

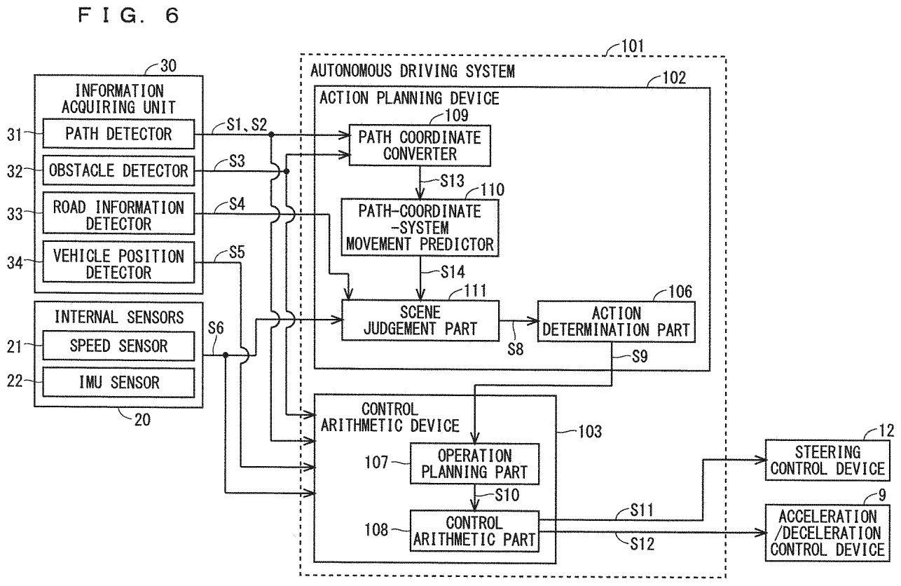

FIG. 6 is a block diagram showing one example of an action planning device 102 and a control arithmetic device 103 according to Embodiment 2. FIG. 6 is a block diagram configured by an information acquiring unit 30, internal sensors 20, the action planning device 102, the control arithmetic device 103, a steering control device 12, and an acceleration/deceleration control device 9. FIG. 6 differs from FIG. 2 in that the action planning device 102 further includes a path coordinate converter 109 and that the plane-coordinate-system movement predictor 104 is replaced by a path-coordinate-system movement predictor 110. The constituent elements other than the path coordinate converter 109, the path-coordinate-system movement predictor 110, and a scene judgement part 111 are the same as those in FIG. 2, and therefore a description thereof shall be omitted.

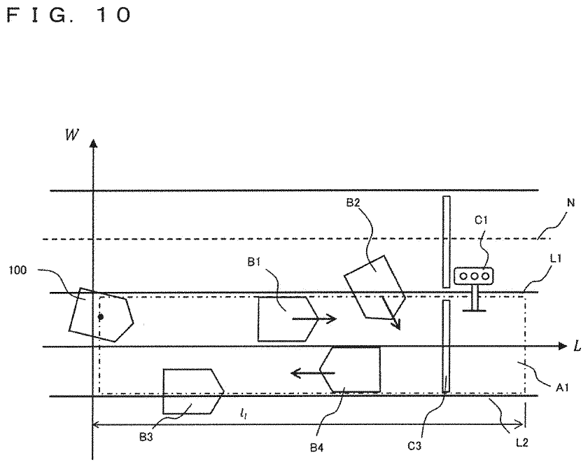

The path coordinate converter 109 converts the plane-coordinate-system obstacle information S3 into a path coordinate system on the basis of the reference path S1 and the travelable region S2 received from the path detector 31 and the plane-coordinate-system obstacle information S3 received from the obstacle detector 32, and outputs the path coordinate system as path-coordinate-system obstacle information S13. The path coordinate converter 109 also uses the travelable region S2 when converting the plane-coordinate-system obstacle information S3, and therefore the action determination part 106 is capable of determining the action of the vehicle 100 that takes even the travelable region S2 into consideration. It is, however, noted that the travelable region S2 is not necessarily required as an input to the path coordinate converter 109. On the basis of at least the reference path S1 and the plane-coordinate-system obstacle information S3 that expresses, in a plane coordinate system, obstacles detected around the periphery of the vehicle by the external sensors mounted on the vehicle, the path coordinate converter converts the plane-coordinate-system obstacle information S3 into a path coordinate system using the reference path S1 as a reference and outputs the path coordinate system as the path-coordinate-system obstacle information S13. The details of the path coordinate system will be described later with reference to FIG. 10.

The path-coordinate-system movement predictor 110 predicts the movements of obstacles in the path coordinate system on the basis of the path-coordinate-system obstacle information S13 received from the path coordinate converter 109, and outputs the result of prediction as path-coordinate-system obstacle movement information S14. The path-coordinate-system movement predictor 110 predicts the movements of the obstacles, using the speed of the obstacles received from the obstacle detector 32 and assuming that the obstacles make a uniform linear motion in the direction of the speed of the obstacles. Assuming the uniform linear motion of the obstacles simplifies the computation of the prediction made by the path-coordinate-system movement predictor 110 and reduces computational complexity. Although the path-coordinate-system movement predictor 110 predicts the movements of the obstacles in the same cycle as the operating cycle of the action planning device 102, if this cycle is short enough, the movements may be predicted from only the positions of the obstacles in each cycle. In this case, the obstacle information received from the obstacle detector 32 indicates the positions of the obstacles.

The scene judgement part 111 determines the conditions of obstacles, road circumstances, and the running progress of the vehicle 100 through the use of the path-coordinate-system obstacle movement information S14 received from the path-coordinate-system movement predictor 110, the road information S4 received from the road information detector 33, and the sensor information S6 received from the internal sensors 20 and outputs the situation in the vehicle 100 as the scene information S8. Alternatively, the scene judgement part 111 may use the path-coordinate-system obstacle movement information S14 to determine the conditions of the obstacles and to output the situation in the vehicle 100 as the scene information S8. As another alternative, the scene judgement part 111 may use the path-coordinate-system obstacle movement information S14 and the road information S4 to determine the conditions of the obstacles and road circumstances and output the situation in the vehicle 100 as the scene information S8. It is, however, noted that the additional use of the road information S4 or the sensor information S6 enables judging a wider range of circumstances. The scene judgement part 111 differs from the scene judgement part 105 illustrated in FIG. 2 in that the path-coordinate-system obstacle movement information S14 is used, instead of the plane-coordinate-system obstacle movement information S7, but they have the same function and therefore a description thereof shall be omitted.

The action planning device 102 and the control arithmetic device 103 illustrated in FIG. 6 are mounted as the autonomous driving system 101 in the vehicle 100 illustrated in FIG. 1.

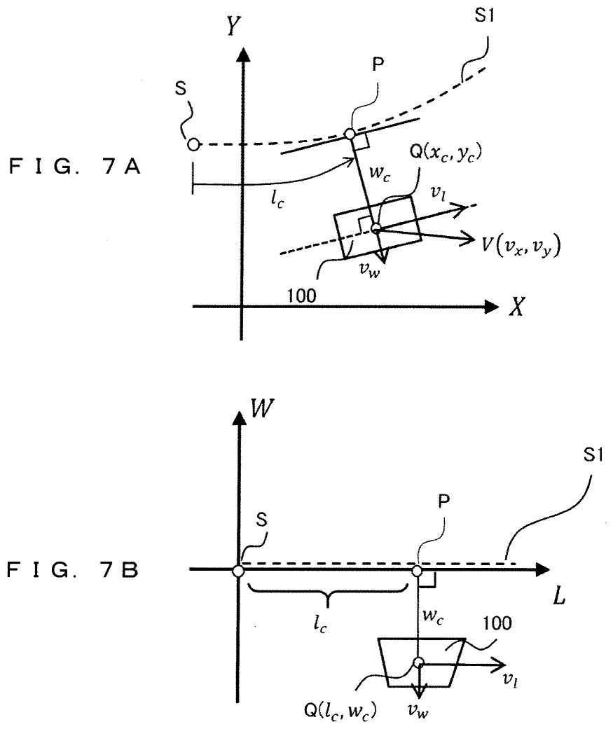

Next, the path coordinate system will be described with reference to FIG. 7. FIGS. 7(a) and 7(b) are schematic diagrams showing one example of the vehicle 100 in the plane coordinate system and in the path coordinate system according to Embodiment 2. FIG. 7(a) is a schematic diagram expressed in the plane coordinate system, and FIG. 7(b) is a schematic diagram expressed in the path coordinate system. The path coordinate system is an LW coordinate system that defines a length direction L of the reference path S1 as a first axis and a direction W orthogonal to the first axis as a second axis. The path coordinate system is generally convertible from the plane coordinate system.

A representative point Q of the vehicle 100 illustrated in FIG. 7(a) is converted into that in the path coordinate system illustrated in FIG. 7(b). The representative point Q may, for example, be the centroid of the vehicle 100 or the center of a sensor. As illustrated in FIG. 7(a), when the reference path S1 is given, an arbitrary point on the reference path S1 is assumed to be a starting point S (which is desirably the nearest point from the vehicle 100 or a point rearward of the vehicle 100). The length direction of the reference path S1 along the reference path S1 from the starting point S is assumed to be the L axis, and the axis orthogonal to the reference path S1 is assumed to be the W axis. The point of intersection of the normal from the representative point Q to the reference path S1 with the reference path S1 is assumed to be a point P. The coordinates (x_{c}, y_{c}) of the representative point Q in the plane coordinate system are converted into the coordinates (l_{c}, w_{c}) in the path coordinate system, where l_{c} is the length from the starting point S to the point P along the reference path S1 and we is the length from the point P to the representative point Q. Moreover, the velocity vector V (vₓ, v_{y}) of the vehicle 100 detected in the plane coordinate system illustrated in FIG. 7(a) is decomposed into a tangential directional component vi of the reference path S1 at the point P and an orthogonal directional component v_{w} thereof, and this can be used as the velocity of the path coordinate system. As illustrated in FIG. 7(b), the conversion into the path coordinate system makes it easy to determine whether the vehicle 100 is running along the path or away from the path. Similar judgement can also be made for obstacles detected in the plane coordinate system through conversion into the path coordinate system. In this way, the position and speed at an arbitrary point in the plane coordinate system can be converted into the position and speed at the corresponding point in the path coordinate system through the use of the reference path S1. As described above, the path coordinate converter 109 converts the positions and speeds of the vehicle 100 and obstacles from the plane coordinate system into the path coordinate system.

Note that in the case where the reference path S1 is the center of a traffic lane, the path coordinate system can be translated into a center-of-traffic-lane coordinate system or a lane coordinate system. If the conversion into the path coordinate system is also possible for mark lines or the like, the travelable region S2 can also be expressed in a form along the path. In this sense, the path coordinate system is in a broader sense than the center-of-traffic-lane coordinate system and the lane coordinate system.

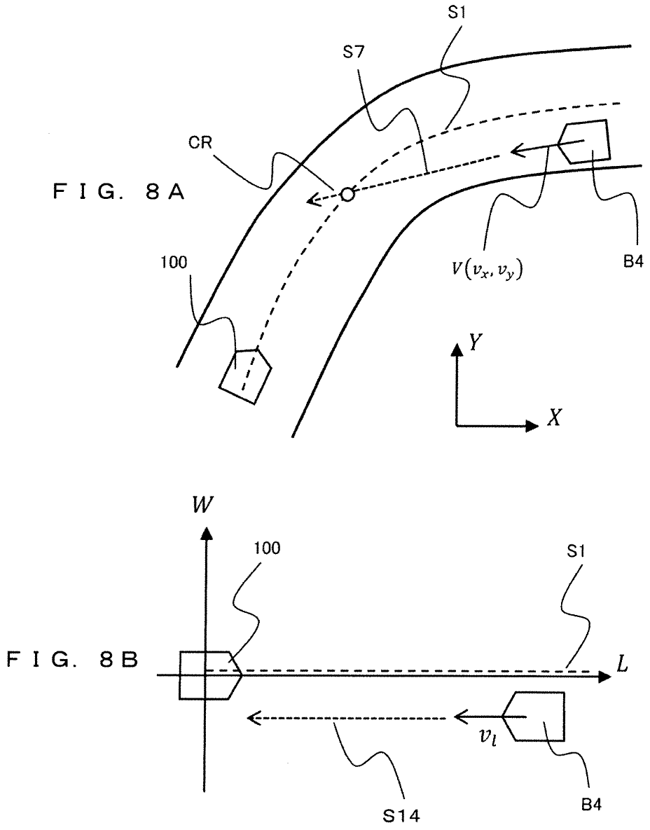

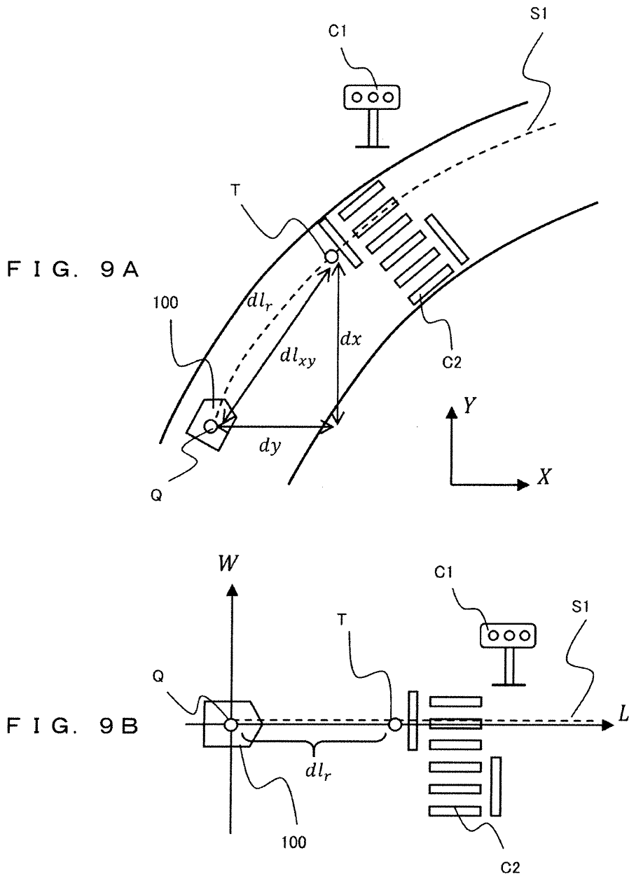

Next, one example of more appropriately determining the action of the vehicle 100 through the use of the path coordinate system will be described with reference to FIGS. 8 and 9. FIGS. 8(a) and 8(b) are schematic diagrams showing one example of the positional relationship between the vehicle 100 and an obstacle when they are running around a curve according to Embodiment 2. FIG. 8(a) is a schematic diagram expressed in the plane coordinate system, and FIG. 8(b) is a schematic diagram expressed in the path coordinate system. FIGS. 9(a) and 9(b) are schematic diagrams showing one example of the positional relationship between the vehicle 100 and the road information S4 when the vehicle is running around a curve according to Embodiment 2. FIG. 9(a) is a schematic diagram expressed in the plane coordinate system, and FIG. 9(b) is a schematic diagram expressed in the path coordinate system.

FIG. 8 illustrates a scene in which there is an oncoming obstacle when the vehicle is running around a curve. It is assumed that the action determination part 106 outputs the action determination result S9 so as to stop the vehicle 100 when it is determined that the obstacle will intersect with the reference path S1 before the vehicle 100. If the movement of the obstacle is predicted in the plane coordinate system, the obstacle is assumed to make a uniform linear motion while maintaining the velocity vector V detected in the plane coordinate system. In this case, as illustrated in FIG. 8(a), it is determined that the obstacle will intersect with an intersection judgement point CR before the vehicle 100, and accordingly the action determination part 106 will output the action determination result S9 so as to stop the vehicle 100. However, in actuality, the obstacle will run along the shape of the road without intersecting with the intersection judgement point CR. That is, the prediction of movements in the plane coordinate system increases the frequency of needless stops and causes deterioration in riding comfort or causes the discomfort of passengers. On the other hand, if the prediction of movements is made in the path coordinate system, as illustrated in FIG. 8(b), the obstacle is assumed to make a uniform linear motion with a velocity of vi in the direction along the reference path S1. In this case, the obstacle is not determined to intersect with the intersection judgement point CR before the vehicle 100. That is, the prediction of movements in the path coordinate system reduces the frequency of stops that may occur when the prediction of movements is made in the plane coordinate system.

FIG. 9 illustrates a scene in which there is a traffic light C1 in the middle of a curve and the traffic light C1 has turned to red. It is assumed that the action determination part 106 outputs the action determination result S9 so as to stop the vehicle 100 before the stop line C3 when the traffic light C1 is red. It is also assumed that the action determination part 106 outputs the distance to a point just before the stop line C3 as a target stop distance. In the plane coordinate system, as illustrated in FIG. 9(a), a distance dl_{xy} from the representative point Q of the vehicle 100 to the target stop position T is calculated as dl_{xy}=(dx²+dy²)^{1/2}. However, the actual distance is a distance dlᵣ along the reference path S1 indicated by the dotted line, and the distance dl_{xy} calculated above is smaller than the distance dlᵣ. Accordingly, there is the possibility that the vehicle may stop before the intended target stop position T. On the other hand, if the distance to the target stop position T is measured in the path coordinate system, as illustrated in FIG. 9(b), the distance dlᵣ to the target stop position T can be measured with accuracy, and the action of the vehicle 100 can be determined more accurately. Although the example of more appropriately determining the action of the vehicle 100 through the use of the path coordinate system has been described thus far, various advantages are achieved not only in the scenes illustrated in FIGS. 8 and 9 but also in the other scenes.

FIG. 10 is a schematic diagram showing one example of a scene in the path coordinate system according to Embodiment 2. As illustrated in FIG. 10, it is assumed that a preceding obstacle B1 (preceding vehicle), a crossing obstacle B2 (crossing vehicle), a stationary obstacle B3 (stationary vehicle), an oncoming obstacle B4 (oncoming vehicle), a traffic light C1, and a stop line C3 are present within a judgement region A1 around the periphery of a vehicle 100. The positions and speeds of these obstacles are assumed to be converted into those in the path coordinate system by the path coordinate converter 109. Note that the judgement region A1 is set to be a region surrounded by a right-side mark line L2, a left-side mark line L1, and a predetermined judgement distance 1i. The scene judgement part 111 judges the conditions of the obstacles that are present within the judgement region A1 around the periphery of the vehicle 100, road circumstances, and the running progress of the vehicle 100 and expresses the situation in the vehicle 100 numerically as the scene information S8. As variables for expressing the scene numerically, the variables shown in Table 1 are prepared. These variables are the same as those used in the scene judgement part 105 according to Embodiment 1. For example, acrbs_inlane=1 is satisfied since the crossing obstacle B2 is present within the judgement region A1 in FIG. 10. This is determined by judging whether wₒ·v_{wo}<0 is satisfied, where wₒ is the position of the obstacle to be judged in the path coordinate system and v_{wo} is the velocity in the W-axis direction. Also, oppobs_inlane=1 is satisfied since the oncoming obstacle B4 is present within the judgement region A1. This is determined by judging whether the velocity in the L-axis direction of the obstacle to be judged in the path coordinate system is negative.

Although the right-side mark line L2, the left-side mark line L1, and an adjacent path N are present in the example illustrated in FIG. 10, if none of them are present, virtual lines or path may be generated and used. The judgement region A1 may be set, using the travelable region S2 output from the path coordinate converter 109.

According to Embodiment 2 of the present disclosure, the scene judgement part 111 converts the situation in the vehicle 100 into numbers in the path coordinate system. Then, the action determination part 106 determines the action of the vehicle 100 on the basis of the scene information S8 converted into numbers. This eliminates the need for inversion from the path coordinate system to the plane coordinate system, which becomes necessary when the target steering amount S11 or the like is directly computed from the prediction of movements of obstacles, and eliminates the need to increase computational loads.

According to Embodiment 2 described above, the prediction of movements of the obstacles is made using the path-coordinate-system obstacle information S13, which is the obstacle information converted by the path coordinate converter 109. Accordingly, it is possible to more appropriately determine the action of the vehicle 100 and to improve the accuracy of autonomous driving.

### Embodiment 3

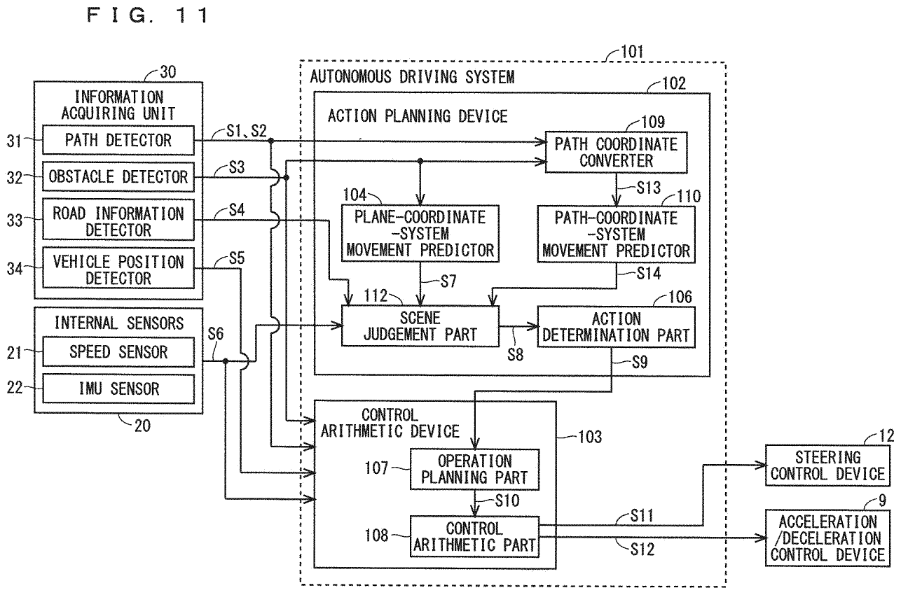

Embodiment 3 describes a method of judging a scene in both of the plane coordinate system and the path coordinate system. FIG. 11 is a block diagram showing one example of an action planning device 102 and a control arithmetic device 103 according to Embodiment 3. FIG. 11 is a block diagram configured by an information acquiring unit 30, internal sensors 20, the action planning device 102, the control arithmetic device 103, a steering control device 12, and an acceleration/deceleration control device 9. FIG. 11 differs from FIGS. 2 and 6 in that the action planning device 102 includes both of the plane-coordinate-system movement predictor 104 and the path-coordinate-system movement predictor 110. The constituent elements other than a scene judgement part 112 are the same as those illustrated in FIGS. 2 and 6, and therefore a description thereof shall be omitted.

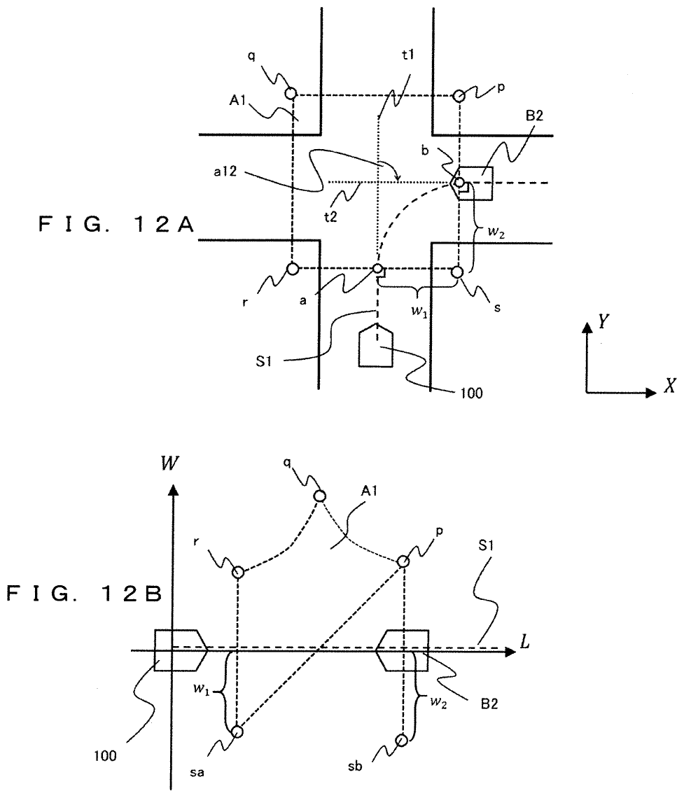

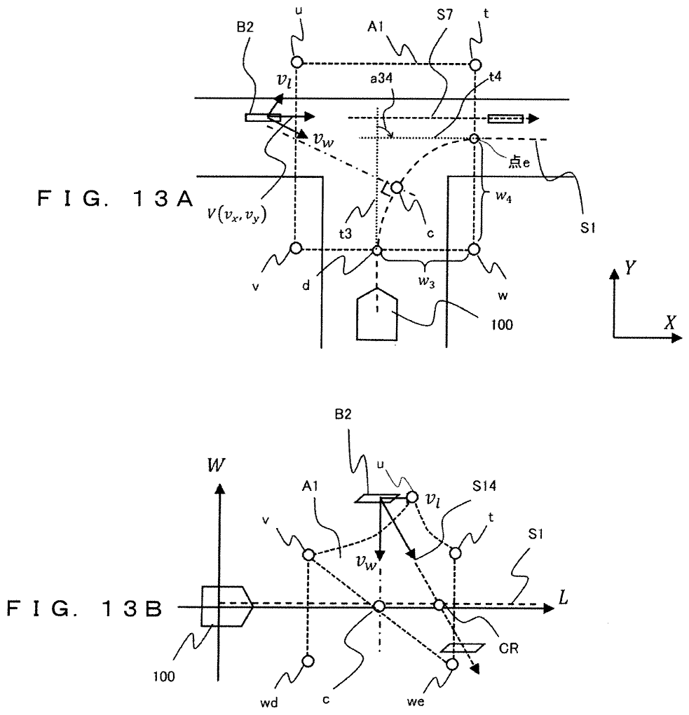

The scene judgement part 112 determines the conditions of obstacles, road circumstances, and the running progress of the vehicle 100 through the use of the plane-coordinate-system obstacle movement information S7 received from the plane-coordinate-system movement predictor 104, the path-coordinate-system obstacle movement information S14 received from the path-coordinate-system movement predictor 110, the road information S4 received from the road information detector 33, and the sensor information S6 received from the internal sensors 20, and outputs the situation in the vehicle 100 as the scene information S8. Alternatively, the scene judgement part 112 may use the plane-coordinate-system obstacle movement information S7 and the path-coordinate-system obstacle movement information S14 to determine the conditions of the obstacles and output the situation in the vehicle 100 as the scene information S8. As another alternative, the scene judgement part 112 may judge the conditions of the obstacles through the use of the plane-coordinate-system obstacle movement information S7, the path-coordinate-system obstacle movement information S14, and the road information S4, and determines the situation in the vehicle 100 as the scene information S8. It is, however, noted that the additional use of the road information S4 and the sensor information S6 enables judging a wider range of circumstances. Hereinafter, a method in which the scene judgement part 112 uses both of the plane-coordinate-system obstacle movement information S7 and the path-coordinate-system obstacle movement information S14 will be described with reference to FIGS. 12 and 13. Note that the action planning device 102 and the control arithmetic device 103 illustrated in FIG. 11 are mounted as the autonomous driving system 101 on the vehicle 100 illustrated in FIG. 1.

FIGS. 12(a) and 12(b) are schematic diagrams showing one example of the positional relationship between the vehicle 100 and an obstacle when they are running around an intersection according to Embodiment 2. FIG. 12(a) is a schematic diagram expressed in the plane coordinate system, and FIG. 12(b) is a schematic diagram expressed in the path coordinate system. FIGS. 13(a) and 13(b) are schematic diagrams showing one example of the positional relationship between the vehicle 100 and an obstacle when they are running around a T junction according to Embodiment 2. FIG. 13(a) is a schematic diagram expressed in the plane coordinate system, and FIG. 13(b) is a schematic diagram expressed in the path coordinate system.

FIG. 12 illustrates a scene in which a crossing obstacle B2 (another vehicle) enters the intersection within the judgement region A1. The judgement region A1 is configured by a plurality of preset points p to s. It is assumed that the action determination part 106 outputs the action determination result S9 so as to stop the vehicle 100 before the intersection when the obstacle enters the judgement region A1. If the prediction of movements of the obstacle is made in the plane coordinate system, as illustrated in FIG. 12(a), the entering of the obstacle into the intersection within the judgement region A1 is properly judged. On the other hand, if the prediction of movements of the obstacle is made in the path coordinate system, as illustrated in FIG. 12(b), the points p to s are converted into those in the path coordinate system. At this time, the conversion into the path coordinate system is made based on the normal from each point to the reference path S1, but in the case of the point s, two normals exist and accordingly there are two points of intersection a and b corresponding to these two normals. As a result, two candidates sa and sb for the converted point are elected in the path coordinate system. In the plane coordinate system, the point corresponding to a smaller one of w₁ and w₂ becomes the candidate for the converted point, where w₁ is the distance from the point s to the point d and w₂ is the distance from the point s to the point d. If w₁>w₂, the point 4b becomes the candidate for the converted point. In this case, the region surrounded by the points p, q, r, and sb becomes the judgement region A1, and it is judged that an obstacle is entering the judgement region A1, i.e., a correct judgement result is obtained. If w₁<w₂, the point sa becomes the candidate for the converted point. In this case, the region surrounded by the points p, q, r, and sa becomes the judgement region A1, and it is judged that no obstacles are entering the judgement region A1, i.e., an erroneous judgement result is obtained.

As illustrated in FIG. 12(a), in the case where a plurality of points that configure the judgement region A1 are each converted into a point in the path coordinate system and if there are a plurality of candidates for the converted point corresponding to the point before conversion, an erroneous judgement result may be obtained. At this time, a maximum value for an angle a12 (hereinafter, referred to as a “reference angle”) formed by the tangential lines at the two points on the reference path S1 within the judgement region A1 increases. In FIG. 12(a), the angle formed by a tangential line t1 at the point a and a tangential line t2 at the point b becomes a reference angle of approximately 90 degrees. The reference angle does not increase around an ordinary curve, but increases at an intersection. Thus, if the reference angle is great, an erroneous judgement result may be obtained. Besides, in the case of FIG. 12(a), the difference between the distances w₁ and w₂ is small. In this case as well, an erroneous judgement result may be obtained. In view of this, the scene judgement part 112 properly uses the plane-coordinate-system obstacle movement information S7 and the path-coordinate-system obstacle movement information S14 depending on the scene. In the case where there are two or more converted points corresponding to a given point before conversion into the path coordinate system, the scene judgement part 112 generates the scene information S8 on the basis of the plane-coordinate-system obstacle movement information S7. In the case where there is only one converted point, the scene judgement part 112 generates the scene information S8 on the basis of the path-coordinate-system obstacle movement information S14. Alternatively, in the case where the maximum value for the angle a12 formed by the tangential lines at the two points on the reference path S1 within the judgement region D1 used by the scene judgement part 112 is greater than a predetermined value (e.g., 90 degrees), the scene judgement part 112 generates the scene information S8 on the basis of the plane-coordinate-system obstacle movement information S7. In the case where the maximum value for this angle is smaller than or equal to the predetermined value, the scene judgement part 112 generates the scene information S8 on the basis of the path-coordinate-system obstacle movement information S14. As another alternative, in the case where there are a plurality of converted points and if the difference in length between the two normals from the point before conversion to the reference path S1 is smaller than or equal to the predetermined value, the scene judgement part 112 generates the scene information S8 on the basis of the plane-coordinate-system obstacle movement information S7. In the case where the difference in length between the two normals is greater than or equal to the predetermined value, the scene judgement part 112 generates the scene information S8 on the basis of the path-coordinate-system obstacle movement information S14.

FIG. 13 illustrates a scene in which the crossing obstacle B2 (bicycle) is running from the side at a T junction and the vehicle 100 is turning to the right. The judgement region A1 is configured by a plurality of points 5 to 8 that are set in advance. It is assumed that the action determination part 106 outputs the action determination result S9 so as to stop the vehicle 100 when it is determined that the obstacle will intersect with the reference path S1 within the judgement region A1 in the near future. If the prediction of movements of the obstacle is made in the plane coordinate system, as illustrated in FIG. 13(a), the obstacle is running across the T junction in the direction of a predetermined velocity vector V, but is determined not to intersect with the reference path T. Thus, a correct action is determined, i.e., the vehicle 100 is running side by side with the obstacle without making a stop. This avoids needless stops of the vehicle. On the other hand, if the prediction of movements of the obstacle is made in the path coordinate system, the points t to w are converted into those in the path coordinate system as illustrated in FIG. 13(b). At the same time, the position and speed of the obstacle are also converted into those in the path coordinate system, using the point of intersection c between the reference path S1 and the normal from the obstacle in FIG. 13(a) to the reference path S1. The points t to w are also converted into those in the path coordinate system on the basis of the normal from each point to the reference path S1, but in the case of the point w, two normals exist and accordingly there are two pints of intersection d and e corresponding to these two normals. As a result, two candidates wd and we for the converted point are elected in the path coordinate system. In the plane coordinate system, the point corresponding to a smaller one of w₄ and w₃ becomes the candidate for the converted point, where w₃ is the distance from the point w to the point d and w₄ is the distance from the point w to the point e. If w₃<w₄, the point wd becomes the candidate for the converted point. In this case, the region surrounded by the points t, u, v, and wd becomes the judgement region A1, and since the point of intersection between the reference path S1 and the obstacle that is assumed to make a uniform linear motion (intersection judgement point CR) is not included within the judgement region A1, it is judged that the obstacle will not intersect with the reference path S1 within the judgement region A1, i.e., a correct judgement result is obtained. If w₃>w₄, the point we becomes the candidate for the converted point. In this case, the region surrounded by the points t, u, v, and we becomes the judgement region A1, and the point of intersection between the reference path S1 and the obstacle that is assumed to make a uniform linear motion (intersection judgement point CR) is not included within the judgement region A1, it is judged that the obstacle will intersect with the reference path S1, i.e., an erroneous judgement result is obtained.

As illustrated in FIG. 13(a), in the case where a plurality of points that configure the judgement region A1 are each converted into that in the path coordinate system and if there are a plurality of candidates for the converted point corresponding to the point before conversion, an erroneous judgement result may be obtained. At this time, the reference angle increases. In FIG. 13(a), the angle formed by a tangential line t3 at the point d and a tangential line t4 at the point e becomes a reference angle of approximately 90 degrees. Since the reference angle also increases at a T junction, like at an intersection, an erroneous judgement result may be obtained if the reference angle is great. Besides, in FIG. 13(a), the difference between the distances w₃ and w₄ is small. In this case as well, an erroneous judgement result may be obtained. In view of this, the scene judgement part 112 properly uses the plane-coordinate-system obstacle movement information S7 and the path-coordinate-system obstacle movement information S14 in the same manner as described with reference to FIG. 12.

The scene judgement part 112 properly uses the plane-coordinate-system obstacle movement information S7 and the path-coordinate-system obstacle movement information S14 depending on the scene. Therefore, appropriate scene judgement can be made not only for the scenes illustrated in FIGS. 12 and 13, but also for all scenes. Note that, in the conditions for selecting the plane-coordinate-system obstacle movement information S7 and the path-coordinate-system obstacle movement information S14, a predetermined value that is to be compared with the maximum value for the angle formed by the tangential lines at two points and a predetermined value that is to be compared with the difference in length between the two tangential lines do not necessarily have to be fixed values, and may be variable.

According to Embodiment 3 described above, the plane-coordinate-system obstacle movement information S7 and the path-coordinate-system obstacle movement information S14 are properly used depending on the scene. Accordingly, it is possible to more appropriately determine the action of the vehicle 100 and thereby to improve the accuracy of autonomous driving.

### Embodiment 4

In recent years, each country has pursued the maintenance of high-precision maps that distribute high-precision static and dynamic information for autonomous driving of the vehicle 100. Non-Patent Document 1 describes the type of information distributed by a high-precision map.

According to Non-Patent Document 1, the high-precision map is obtained by superimposing dynamic data classified by the frequency of updates of information on a basic map (static information). The dynamic data is classified into quasi-static information, sub-dynamic information, and dynamic information. The quasi-static information is updated at frequencies of one day or less and may include, for example, traffic regulation information and road construction information. The sub-dynamic information is updated at frequencies of one hour or less and may include, for example, accident information and traffic-jam information. The dynamic information is updated at frequencies of one second or less and may include, for example, traffic-light information and pedestrian information.

Like the GNSS sensor 27, the high-precision map generally uses a planetographic coordinate system. The high-precision map is generally composed of wide-area data in units of several hundred kilometers. Thus, the use of the high-precision map enables acquiring information about a wider area in advance and determining the action of the vehicle 100 in consideration of circumstances in a wider area. Since the high-precision map includes the basic map and the dynamic data, it is also possible to acquire obstacle information. Therefore, the configuration of the information acquiring unit 30 can be simplified by combining the high-precision map and the GNSS sensor 27. Besides, it is possible to improve the accuracy of the action determination result S9 output from the action planning device 102 and the accuracy of the target steering amount S11 and the target acceleration/deceleration amount S12 output from the control arithmetic device 103.

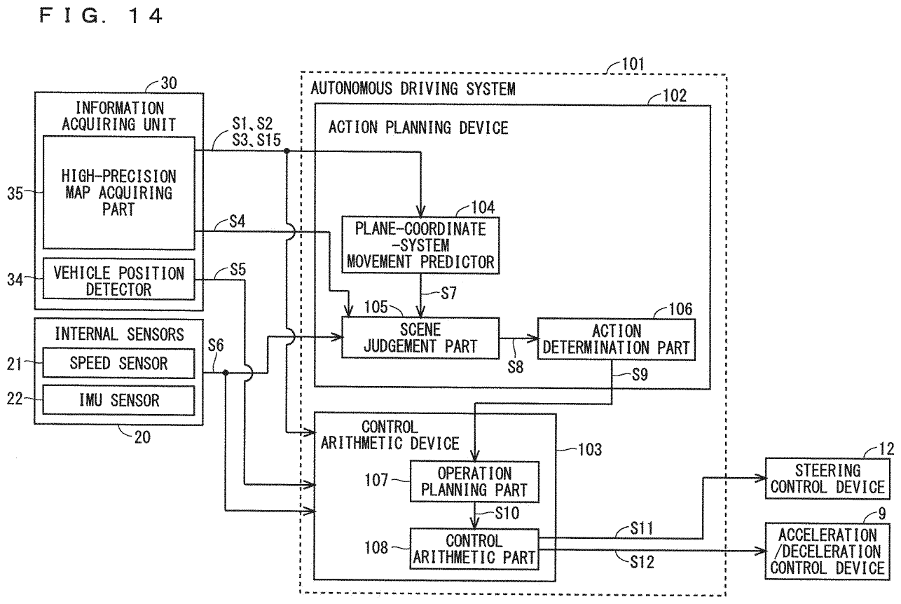

FIG. 14 is a block diagram showing one example of an action planning device 102 and a control arithmetic device 103 according to Embodiment 4. FIG. 14 is a block diagram configured by an information acquiring unit 30, internal sensors 20, the action planning device 102, the control arithmetic device 103, a steering control device 12, and an acceleration/deceleration control device 9. FIG. 14 differs from FIG. 2 in that the path detector 31, the obstacle detector 32, and the road information detector 33 are replaced by a high-precision map acquiring part 35. The constituent elements other than the high-precision map acquiring part 35 are the same as those illustrated in FIG. 2, and therefore a description thereof shall be omitted.

The high-precision map acquiring part 35 acquires a high-precision map and outputs the reference path S1, the travelable region S2, the map information S15, the plane-coordinate-system obstacle information S3, and the road information S4. These pieces of information are expressed in the plane coordinate system. Thus, like the vehicle position detector 34, the high-precision map acquiring part 35 has the function of converting information expressed in the planetographic coordinate system into information expressed in the plane coordinate system. Note that the plane-coordinate-system obstacle information S3 does not necessarily have to be output from the high-precision map acquiring part 35, and may be output from the obstacle detector 32. Although the information acquired by the high-precision map acquiring part 35 and the vehicle position detector 34 is described as being expressed in the planetographic coordinate system, the coordinate system is not limited to the planetographic coordinate system. The high-precision map acquiring part 35 is also applicable to the action planning devices 102 and the control arithmetic devices 103 illustrated in FIGS. 2, 6, and 13.

The action planning device 102 and the control arithmetic device 103 illustrated in FIG. 14 are mounted as the autonomous driving system 101 on the vehicle 100 illustrated in FIG. 1.

According to Embodiment 4 described above, the use of the high-precision map enables improving the accuracy of the action determination result S9 output from the action planning device 102 and the accuracy of the target steering amount S11 and the target acceleration/deceleration amount S12 output from the control arithmetic device 103. This improves the accuracy of autonomous driving.

Although the action planning devices 102 and the control arithmetic devices 103 according to Embodiments 1 to 4 are described as being applied to the autonomous driving of the vehicle 100, the application of these devices and units is not limited to autonomous driving, and these devices and units may also be applicable to various moving objects. For example, these devices and units may be applied to moving objects that require safe operations, such as in-building mobile robots for inspecting the inside of buildings, line inspection robots, and personal mobilities.

### EXPLANATION OF REFERENCE SIGNS

1 steering wheel
2 steering shaft
3 electric motor
4 rack-and-pinion mechanism
5 tie rod
6 front knuckle
7 vehicle driving device
8 shaft
9 acceleration/deceleration control device
10 brake control device
11 brake
12 steering control device
13 pinion shaft
14 rack shaft
15 front wheel
16 rear wheel
20 internal sensor
21 speed sensor
22 IMU sensor
23 steering angle sensor
24 steering torque sensor
25 camera
26 radar
27 GNSS sensor
28 navigation device
29 LiDAR
30 information acquiring unit
31 path detector
32 obstacle detector
33 road information detector
34 vehicle position detector
35 high-precision map acquiring part
100 vehicle
101 autonomous driving system
102 action planning device
103 control arithmetic device
104 plane-coordinate-system movement predictor
105, 111, 112 scene judgement part
106 action determination part
107 operation planning part
108 control arithmetic part
109 path coordinate converter
110 path-coordinate-system movement predictor
S1 reference path
S2 travelable region
S3 plane-coordinate-system obstacle information
S4 road information
S5 vehicle positional information
S6 sensor information
S7 plane-coordinate-system obstacle movement information
S8 scene information
S9 action determination result
S10 target track
S11 target steering amount
S12 target acceleration/deceleration amount
S13 path-coordinate-system obstacle information
S14 path-coordinate-system obstacle movement information
S15 map information
A1 judgement region
B1 preceding obstacle
B2 crossing obstacle
B3 stationary obstacle
B4 oncoming obstacle
C1 traffic light
C2 pedestrian crossing
C3 stop line
L1 left-side mark line
L2 right-side mark line
N adjacent path
Q representative point
S starting point
T target stop position
CR intersection judgement point

1. An action planning device comprising:
processing circuitry
to predict a movement of an obstacle in accordance with plane-coordinate-system obstacle information which expresses the obstacle in a plane-coordinate-system and to generate a result of prediction as plane-coordinate-system obstacle movement information;
to judge a condition of the obstacle in accordance with the plane-coordinate-system obstacle movement information and to generate a situation in a moving object as scene information; and
to determine an action of the moving object in accordance with the scene information and to output a result of determination as an action determination result to a control arithmetic device that calculates a target value for controlling the moving object according to the action determination result.

2. An action planning device comprising:
processing circuitry
to convert plane-coordinate-system obstacle information into information in a path coordinate system using a reference path as a reference, in accordance with the plane-coordinate-system obstacle information which expresses an obstacle in a plane-coordinate-system and the reference path serving as a standard of running of a moving object, and to generate a result of conversion as path-coordinate-system obstacle information;
to predict a movement of the obstacle in accordance with the path-coordinate-system obstacle information and to generate a result of prediction as path-coordinate-system obstacle movement information;
to judge a condition of the obstacle in accordance with the path-coordinate-system obstacle movement information and to generate a situation in the moving object as scene information which expresses numerically; and
to determine an action of the moving object in accordance with the scene information and to output a result of determination as an action determination result to a control arithmetic device that calculates a target value for controlling the moving object according to the action determination result.

3. The action planning device according to claim 1, wherein:
the processing circuitry is further configured
to convert the plane-coordinate-system obstacle information into information in a path coordinate system using a reference path as a reference, in accordance with the plane-coordinate-system obstacle information and the reference path serving as a standard of running of the moving object, and to generate a result of conversion as path-coordinate-system obstacle information;
to predict the movement of the obstacle in accordance with the path-coordinate-system obstacle information and to generate a result of prediction as path-coordinate-system obstacle movement information; and
to judge the condition of the obstacle in accordance with the plane-coordinate-system obstacle movement information and the path-coordinate-system obstacle movement information and generate a situation in the moving object as the scene information.

4. The action planning device according to claim 1, wherein
the processing circuitry is further configured to judge the condition of the obstacle and a road circumstance in accordance with the plane-coordinate-system obstacle movement information and road information, and to generate the situation in the moving object as the scene information.

5. The action planning device according to claim 2, wherein
the processing circuitry is further configured to judge the condition of the obstacle and a road circumstance in accordance with the plane-coordinate-system obstacle movement information and road information, and to generate the situation in the moving object as the scene information.

6. The action planning device according to claim 3, wherein
the processing circuitry is further configured to judge the condition of the obstacle and a road circumstance in accordance with the plane-coordinate-system obstacle movement information, the path-coordinate-system obstacle movement information, and road information, and to generate the situation in the moving object as the scene information.

7. The action planning device according to claim 3, wherein
the processing circuitry is further configured to convert each point of a plurality of points that are preset to configure a judgement region which is a range for determining the situation in the moving object into a point in the path coordinate system, and to generate a result of conversion as a converted point,
when two or more converted points, each being the converted point, correspond to the each point that is before the conversion into the path coordinate system, the processing circuitry generates the scene information in accordance with the plane-coordinate-system obstacle movement information, and
when one converted point that is the converted point corresponds to the each point that is before the conversion into the path coordinate system, the processing circuitry generates the scene information in accordance with the path-coordinate-system obstacle movement information.

8. The action planning device according to claim 3, wherein
when a maximum value for an angle formed by tangential lines at two points on the reference path is greater than a predetermined value, the reference path being within the judgement region which is a range for determining the situation in the moving object, the processing circuitry generates the scene information in accordance with the plane-coordinate-system obstacle movement information, and
when the maximum value of the angle is less than or equal to the predetermined value, the processing circuitry generates the scene information in accordance with the path-coordinate-system obstacle movement information.

9. The action planning device according to claim 1, wherein
the processing circuitry predicts the movement of the obstacle in accordance with, as the plane-coordinate-system obstacle information, either a position of the obstacle or both the position of the obstacle and a speed of the obstacle.

10. The action planning device according to claim 2, wherein
the processing circuitry predicts the movement of the obstacle in accordance with, as the path-coordinate-system obstacle information, either a position of the obstacle or both the position of the obstacle and a speed of the obstacle.

11. The action planning device according to claim 3, wherein
the processing circuitry predicts the movement of the obstacle in accordance with, as the plane-coordinate-system obstacle information, either a position of the obstacle or both the position of the obstacle and a speed of the obstacle, and
the path-coordinate-system movement predictor predicts the movement of the obstacle in accordance with, as the path-coordinate-system obstacle information, either the position of the obstacle or both the position of the obstacle and the speed of the obstacle.

12. The action planning device according to claim 1, wherein
the processing circuitry predicts the movement, assuming that the obstacle makes a uniform linear motion.

13. The action planning device according to claim 2, wherein
the processing circuitry predicts the movement, assuming that the obstacle makes a uniform linear motion.

14. The action planning device according to claim 3, wherein
the processing circuitry predicts the movement, assuming that the obstacle makes a uniform linear motion, and
the processing circuitry predicts the movement, assuming that the obstacle makes a uniform linear motion.

15. The action planning device according to claim 1, wherein
the processing circuitry expresses the scene information numerically.

16. The action planning device according to claim 1, wherein
the processing circuitry expresses the scene information symbolically.

17. The action planning device according to claim 1, wherein
the processing circuitry determines the action of the moving object by a finite-state machine.

18. The action planning device according to claim 1, wherein
the action determination result is at least one of effectiveness that indicates whether the action determination result is valid, a target action of the moving object, a target path number that is allocated in advance to a target path of the moving object, reference path information about the reference path serving as a standard of running of the moving object, an upper limit speed based on a legal speed of the moving object, a lower limit speed that is at least necessary for the moving object, a target stop position at which the moving object is stopped, or a target stop distance from a current position of the moving object to the target stop position.

19. A control arithmetic device for computing a target value in accordance with an action determination result that is output from the action planning device according to claim 1.

20. The action planning device according to claim 2, wherein
the processing circuitry determines the action of the moving object by a finite-state machine.

21. The action planning device according to claim 2, wherein
the action determination result is at least one of effectiveness that indicates whether the action determination result is valid, a target action of the moving object, a target path number that is allocated in advance to a target path of the moving object, reference path information about the reference path serving as a standard of running of the moving object, an upper limit speed based on a legal speed of the moving object, a lower limit speed that is at least necessary for the moving object, a target stop position at which the moving object is stopped, or a target stop distance from a current position of the moving object to the target stop position.

22. A control arithmetic device for computing a target value in accordance with an action determination result that is output from the action planning device according to claim 2.
